(19) United States
(12) Patent Application Publication
(10) Pub. No.: US 2009/0261706 A1
(43) Pub. Date: Oct. 22, 2009

(54) LED Replacement Light Tube for Fluorescent Light Fixture

(76) Inventors: Eliot Sorella, Laval (CA); Jonas J. Robertson, Harvey, LA (US)

Correspondence Address: MEREK, BLACKMON & VOORHEES, LLC, 673 S. WASHINGTON ST., ALEXANDRIA, VA, 22314, US

(21) Appl. No.: 12/361,349

(22) Filed: Jan. 28, 2009

Related U.S. Application Data
(60) Provisional application No. 61/023,904, filed on Jan. 28, 2008.

(51) Int. Cl. H01J 61/52

(52) U.S. Cl. 313/46

(57) ABSTRACT

The present invention relates generally to electrical lighting devices and systems, and more particularly to a light tube replacement for use with fluorescent light fixtures. The replacement light tube comprises a series of light emitting diodes (LEDs) and a heat sink therefore incorporated adjacent a clear or translucent cover configured for installation in a conventional fluorescent light fixture. The present LED replacement light includes suitable light directing and/or diffusing means and compatible connector pins and electrical componentry as required for installation and operation in an existing fluorescent light circuit. Alternatively, the replacement light may utilize conventional 110-115 volt alternating current or backup battery power as the electrical power source. Preferably, the light cover and the heat sink surrounding the LEDs when assembled together have a substantially cylindrical shape to be easily recognizable as a fluorescent light tube replacement and to effectively appear as a fluorescent light tube when installed in a fixture.

### BACKGROUND OF THE INVENTION

1. Field of the Invention

The present invention relates generally to electrical lighting devices and systems, and more particularly to a light tube replacement for use with fluorescent light fixtures. The replacement light tube comprises a series of light emitting diodes (LEDs) and a heat sink therefore incorporated adjacent a clear or translucent cover configured for installation in a conventional fluorescent light fixture. The present LED replacement light includes suitable light directing and/or diffusing means and compatible connector pins and electrical componentry as required for installation and operation in an existing fluorescent light circuit. Alternatively, the replacement light may utilize conventional 110-115 volt alternating current or backup battery power as the electrical power source. Preferably, the light cover and the heat sink surrounding the LEDs when assembled together have a substantially cylindrical shape to be easily recognizable as a fluorescent light tube replacement and to effectively appear as a fluorescent light tube when installed in a fixture.

2. Description of the Related Art

A number of different principles of electrical lighting have been developed over the years. Incandescent lighting was the first lighting principle to receive widespread use, and is still the most widely used lighting principle used to date. More recently, the principle of electrically exciting a gas to produce light emission from the gas, has been used to produce usable light in the form of fluorescent lighting fixtures and the like.

Fluorescent lighting operates according to the principle of ionizing a gas contained within a sealed tube. The electrically excited gas produces light emission as it returns to its normal energy level. The light spectrum depends upon the type of gas within the tube, but conventional fluorescent lighting emits light in the ultraviolet spectrum, which is converted to visible light as it encounters the coating within the tube and causes the coating to fluoresce. Such fluorescent lighting also requires a relatively high voltage to produce the required ionization of the gas. This voltage may be provided by a starter which provides an inductive kick when current is shut off or reversed, the ballast serving to limit current in the arc between the filaments, or by high voltage windings loosely wound on the ballast itself in rapid start fluorescent lights.

As can be seen, the fluorescent lighting principle is relatively complex, but is the lighting means of choice in most businesses and the like due to the greater electrical efficiency provided. Nevertheless, repair can be costly in terms of both parts and labor, when ballasts and other components break down and require replacement. Also, the relatively high voltage required of such fluorescent lighting systems requires additional electrical insulation, and requires greater care to provide the degree of safety desired in such electrical devices. Additionally, the mercury used inside the fluorescent light tube can be a safety hazard when a light tube breaks.

Other principles of lighting have been developed more recently. Among these is the LED, or light emitting diode. Light emitting diodes (hereinafter referred to as “LEDs” throughout the present disclosure) operate generally as a conventional diode, i.e., allowing electrical current to pass through the device in one direction while blocking current flow in the opposite direction. LEDs provide another advantage during this operation, in that the passage of electrical current through the device also causes light to be emitted from the device. As development of such LEDs has progressed, different colors of light emission, light intensity, and other factors have also been developed.

LEDs provide many advantages in lighting, where they may be employed. LEDs are relatively cool in operation, and do not produce any significant amount of heat as a byproduct of their operation. Moreover, they are quite efficient in comparison to other types of lighting principles. LEDs are available in a number of different colors, and the lighting intensity may be varied by means of a simple variable resistor or rheostat, unlike fluorescent lighting. However, even with “super bright”LEDs, the light output of a single LED is relatively weak in comparison to a conventional fluorescent light unit. Nonetheless, an assembly of a series of LEDs in a single unit or fixture, can provide an equivalent amount of light to a fluorescent light fixture, at greatly reduced voltage requirements and reduced componentry.

Accordingly, the present invention provides a solution to the problem of relatively costly and fragile componentry used in fluorescent lighting, as well as avoiding the dangers of mercury contained in most fluorescent lights, by providing highly efficient “drop-in” replacement lighting units for fluorescent lighting tubes. The present replacement lighting units comprise various embodiments forming substantially cylindrical units, each containing a relatively large number of LEDs. The lighting units are equipped with support and contact pins which extend from each end of the units and secure in the conventional fluorescent light tube connectors found at opposite ends of every fluorescent light fixture. The present invention may also include electrical componentry required to adapt the operation of an LED array to the electrical system of a fluorescent lighting fixture, with such electrical componentry being provided either internally within the replacement lighting unit or externally, as desired. The present system may bypass the ballast and starter components of the conventional fluorescent circuit, and may also make advantageous use of a rheostat to control the light and/or color output of the LED device, as desired.

Several attempts have been made to utilize LEDs within lighting systems or especially to replace existing lighting. See for instance, U.S. Pat. Nos. 6,860,628, 7,114,830, and 7,249,865, each of which is hereby incorporated by reference.

U.S. Pat. No. 2,713,629 issued on Jul. 19, 1955 to Walter V. Etzkorn, titled “Luminous Bodies,” describes a series of embodiments of a relatively small diameter, flexible plastic tube which includes a number of relatively small glass fluorescent bulbs therein. The purpose of the Etzkorn light construction is to provide a lighting device which may serve in place of conventional neon tubes and the like, with the flexible plastic tube and relatively small, spaced apart light bulbs within the Etzkorn construction providing the flexibility required to allow the device to be bent and shaped as desired. An attempt to install the flexible lighting unit of Etzkorn in a conventional overhead fluorescent lighting fixture, would result in the Etzkorn fixture sagging of its own weight as it spanned the opposite fluorescent sockets of the fixture. Moreover, Etzkorn clearly does not anticipate such a use for his device, as he only describes its connection with a conventional household wiring circuit (col. 2, lines 45-46). As Etzkorn utilizes relatively high voltage components, i.e., fluorescent bulbs, he does not require means for reducing system voltage, as provided by the present invention. Also, it is noted that Etzkorn wires his fluorescent bulbs in parallel, so that the loss of a single bulb does not result in the entire display going out.

U.S. Pat. No. 3,714,414 issued on Jan. 30, 1973 to Alf T. Sternius, titled “Ornamental Lighting Means,” describes a series of embodiments incorporating baseless miniature (incandescent) lamps or bulbs, arranged in series in a holding fixture of some sort. The problems with such incandescent units, i.e., heat, relatively short life, high current draw for the amount of light output, etc., are well known. Sternius only provides a conventional connector plug for electrically connecting his lighting apparatus to a conventional outlet. He clearly does not anticipate using his lighting device in a fluorescent light fixture, with its specially configured sockets, as he does not provide any means of stepping down the voltage of such a fluorescent fixture to that required for his incandescent lights.

U.S. Pat. No. 3,755,663 issued on Aug. 28, 1973 to Ben B. George, Jr., titled “Electrical Display Device And Method Of Making The Same,” describes various embodiments of a lighting device incorporating a number of small, baseless incandescent bulbs in a series-parallel circuit within a flexible plastic tube or sleeve. George, Jr. does not disclose any connector means configured for connecting to a conventional fluorescent light fixture, as provided by the present lighting system invention. The George, Jr. lighting system thus more closely resembles the system of the '629 U.S. patent to Etzkorn and certain embodiments of the '663 U.S. patent to Sternius, both discussed above, than it does the present invention.

U.S. Pat. No. 4,152,618 issued on May 1, 1979 to Osamu Abe et al., titled “Light-Emitting Display Device Including Light Diffusing Film,” describes an assembly including a relatively small light emitting element. The disclosure is not clear as to the principle of operation of the light emitting element, but it appears that an early light emitting diode device is described, at least very generally. However, Abe et al. are primarily concerned with various means for diffusing the light emitted from the light emitting device, rather than with any specific means for replacing an existing lighting device (e.g., a fluorescent tube) with a lighting device incorporating a number of light emitting diodes therein. Accordingly, no specific electrical connection means is disclosed by Abe et al.

U.S. Pat. No. 4,521,835 issued on Jun. 4, 1985 to Daniel H. Meggs et al., titled “Flexible Elongated Lighting System,” describes various embodiments of a lighting system employing a number of LED type lighting devices imbedded within a flexible plastic rod or the like. Meggs et al. describe a number of different internal shapes for the plastic rod, for transmitting or diffusing the light output of the LEDs. Meggs et al. are primarily concerned with emergency lighting systems, and include battery power for their lighting systems. However, they do not provide any means for replacing an existing fluorescent lighting unit with their LED light system, as opposed to the present invention which includes voltage reduction and compatible connection means for replacing a fluorescent tube with a unit of the present invention.

U.S. Pat. No. 4,581,687 issued on Apr. 8, 1986 to Hirobumi Nakanishi, titled “Lighting Means For Illuminative Or Decorative Purpose And Modular Lighting Tube Used Therefor,” describes a series of embodiments of tubular lighting elements employing numerous LED lights therein, in series array. However, Nakanishi states that his lighting elements are flexible, and thus they are not suited for installation across the span of a fluorescent light fixture, as provided by the present rigid lighting elements. Moreover, Nakanishi utilizes end connectors which are incompatible with the conventional sockets found in a fluorescent lighting fixture, and Nakanishi does not disclose any electrical apparatus for reducing the voltage from the higher voltage of a fluorescent fixture or even standard household alternating current.

U.S. Pat. No. 4,665,470 issued on May 12, 1987 to Benjamin B. George, Jr., titled “Decorative Light Tubing And Method Of Manufacture Thereof,” describes the use of a transparent dielectric material which is poured into the light tube in a liquid state, to seal the lighting components therein. George, Jr. describes the bending of the electrical contact wires over the edges of the ends of the tube, to hold them in place. Such a configuration is not at all compatible with installation in a conventional fluorescent light fixture. George, Jr. does not anticipate such an installation for his lighting device, as he does not disclose any electrical componentry to adapt the relatively low power requirements of LED lighting to the high voltage of a fluorescent lighting system.

U.S. Pat. No. 4,901,207 issued on Feb. 13, 1990 to Naoki Sato et al., titled “Light Emission Element Array And Manufacturing Method Thereof,” describes a linear LED array having a converging lens with a cylindrical cross section installed thereover. The Sato et al. disclosure is directed primarily to means for roughening the external surface of the cylindrical lens in order to diffuse the light emanating therefrom, rather than dealing with any specific installation configuration for an LED array. Accordingly, Sato et al. do not disclose any form of physical connection means for their lighting apparatus, nor any electrical components for adapting an LED array to a fluorescent lighting fixture.

U.S. Pat. No. 4,941,072 issued on Jul. 10, 1990 to Masami Yasumoto et al., titled “Linear Light Source,” describes a linear LED array and semicylindrical section lens therefor. As in the case of the '207 U.S. patent to Sato et al. discussed immediately above, Yasumoto et al. do not disclose any specific means for securing their lighting device in any form of fixture, fluorescent or otherwise, and do not disclose any form of electrical apparatus for adapting the relatively low voltage requirements of an LED circuit to the necessarily higher voltage of a fluorescent fixture or even conventional line current.

U.S. Pat. No. 4,943,900 issued on Jul. 24, 1990 to Klaus Gartner, titled “Lighting Fixture,” describes a number of miniature incandescent bulbs electrically connected in series within a translucent tube. Gartner is directed particularly to end attachment means for his lighting tube, with each end connector comprising a male connector which fits into a female socket in the end of the tube. Each end of the Gartner tube contains only a single electrical conductor. The Gartner lighting device is thus incompatible with a fluorescent fixture, with its requirement for two parallel male electrical connector pins extending from each end of the lighting element.

U.S. Pat. No. 5,032,960 issued on Jul. 16, 1991 to Masaaki Katoh, titled “Light Source Device With Arrayed Light Emitting Elements And Manufacturing Therefor,” describes an LED lighting array comprising a linear group of LEDs installed beneath a semicylindrical converging lens. The Katoh configuration more closely resembles the lighting arrays of the Sato et al. '207 U.S. patent, and more particularly the Yasumoto et al. '072 U.S. patent, than it does the present invention. Katoh does not disclose any means for connecting his lighting array electrically or physically with a lighting fixture, and does not disclose any electrical apparatus for adapting his LED array for use in a conventional fluorescent lighting fixture.

U.S. Pat. No. 5,515,253 issued on May 7, 1996 to Fritz C. Sjobom, titled “L.E.D. Light Assembly,” describes a specific lens configuration for diffusing the light produced by an LED lighting array. Sjobom provides a plurality of LEDs on a circuit board, and overlays the assembly with his lens. Moreover, Sjobom does not disclose any form of end connectors for his lighting array, nor does he disclose any electrical apparatus for adapting an LED array for use with the higher voltage of a conventional fluorescent lighting system or 110-115 volt AC supply.

U.S. Pat. No. 5,688,042 issued on Nov. 18, 1997 to Abolfazl Madadi et al., titled “LED Lamp,” describes an elongate bulb having an attachment base at only one end thereof. The lamp includes three elongate circuit boards, each having a series of LEDs installed thereon. The circuit boards are installed within the bulb to emit light in a general omnidirectional pattern. Madadi et al. do not provide any form of reflector or diffuser means with their light, as they intend it to be installed within a double faced, back lighted sign (e.g., exit signs, etc.). Moreover, as they intend their light to be used only in such relatively compact installations, they do not provide the conventional double parallel pin connectors at each end of the bulb.

U.S. Pat. No. 5,810,463 issued on Sep. 22, 1998 to Atsushi Kawahara et al., titled “Illumination Device,” describes an LED lighting device having either a row of LEDs which send their light through a generally cylindrical lens with reflectors thereon, or which may include an array of LEDs at one end of the lens. The lens of the Kawahara et al. lighting device includes a lateral extension, the end or edge of which is adjacent to the linear LED array. This shape is not compatible with installation within a conventional fluorescent light fixture, as provided by the present invention. Moreover, Kawahara et al. do not disclose any electrical apparatus to provide compatibility with the relatively high voltages of a fluorescent lighting system or even conventional household supply current.

U.S. Pat. No. 6,068,383 issued on May 30, 2000 to Roger Robertson et al., titled “Phosphorous Fluorescent Light Assembly Excited By Light Emitting Diodes,” describes a fluorescent lighting device which produces light in the visible spectrum by means of a fluorescent coating within the lighting apparatus, which in turn is excited by ultraviolet light produced by a number of LEDs within the device. The device of the Robertson et al. '383 U.S. patent is thus more closely related to a conventional fluorescent lighting assembly, than to the present invention. The only difference between the assembly of the Robertson et al. '383 U.S. patent and conventional fluorescent fixtures, is that conventional fluorescent lighting produces light in the ultraviolet spectrum by means of ionizing a gas within a tube, with the ultraviolet light produced by the ionized gas causing the fluorescent coating within the tube to fluoresce to produce light in the visible spectrum. The present invention does not produce any form of ultraviolet light; all light produced by the LEDs used in the present lighting apparatus, comprises light in the visible spectrum. There is no need to convert light from the ultraviolet spectrum to the visible spectrum, in the present lighting system invention. Moreover, the Robertson et al. '383 U.S. patent does not disclose any physical configuration for a lighting device which enables it to be installed within a conventional fluorescent lighting fixture.

U.S. Pat. No. 6,139,174 issued on Oct. 31, 2000 to Mark M. Butterworth, titled “Light Source Assembly For Scanning Devices Utilizing Light Emitting Diodes,” describes a solid translucent rod which accepts blue light from an appropriate LED at one end thereof, and transmits the light outwardly through the side of the rod. A pair of fluorescent strips along the side of the rod produce light in different spectra, with a third strip passing the blue light therethrough. The Butterworth light apparatus is adapted for use in a scanning device, as are many of the lighting devices of the prior art discussed further above. Accordingly, no means of installing or operating the Butterworth apparatus in a conventional fluorescent lighting fixture, is disclosed.

U.S. Pat. No. 6,283,612 issued on Sep. 4, 2001 to Mark A. Hunter, titled “Light Emitting Diode Light Strip,” describes an elongate translucent tube with a plurality of LEDs installed in series therein. However, Hunter utilizes a separate power supply to step down the voltage from the conventional 110-220 volt supply to the reduced voltage required even for a series of LEDs. The Hunter power supply is a separate box, wired in series with the light by an elongate flexible cable and removable connector. Moreover, each end of the Hunter lamp includes a flexible cable extending therefrom, which is not compatible for installation in a conventional fluorescent light fixture. In addition, Hunter does not disclose any form of light reflecting or diffusing means for scattering the directional light of the LEDs in a wide spread pattern.

U.S. Pat. No. 6,331,915 issued on Dec. 18, 2001 to Kenneth J. Myers, titled “Lighting Element Including Light Emitting Diodes, Microprism Sheet, Reflector, And Diffusing Agent,” describes sheet(s) of material having a series of prismatic reflective grooves formed therein, and the placement of LEDs along the grooves. A number of additional means of diffusing or scattering the light emitted by the LEDs, is also described generally by Myers. However, the only electrical power source indicated in the Myers disclosure, is a conventional symbol for a battery across two of the LEDs in one of the drawing Figs. No description of this battery, its reference numeral, or any other electrical power means is provided in the text of the disclosure.

U.S. Pat. No. 6,388,393 issued on May 14, 2002 to Lewis Illingworth, titled “Ballasts For Operating Light Emitting Diodes In AC Circuits,” describes various embodiments of inductor and transformer devices for reducing voltage and current to proper levels, for powering LED lighting devices in an aircraft electrical system. Illingworth does not describe any type of connectors for connecting an LED light array in a fluorescent fixture, nor does he describe any means for reflecting or diffusing the light output from an LED array, which features are a part of the present invention. Moreover, Illingworth is directed to relatively low voltages, and particularly DC electrical power systems, as used in aircraft.

Finally, U.S. Pat. No. 7,049,761, issued on May 23, 2006 to Jos Timmermans et al., titled “Light Tube And Power Supply Circuit,” describes an elongate tube having a plurality of LEDs installed therein. Timmermans et al. also describe circuitry and connector means for installing their light in an existing fluorescent light fixture. However, Timmermans et al. vary the angles of their installed LEDs to provide the desired light projection. No light reflective or diffusion means is disclosed by Timmermans et al. in their light.

None of the above inventions and patents, taken either singly or in combination, is seen to describe the instant invention as claimed. Thus an LED replacement for fluorescent lighting solving the aforementioned problems is desired.

### SUMMARY OF THE INVENTION

The present invention comprises a series of embodiments of a replacement lighting unit for a conventional high voltage fluorescent lighting fixture, with the present lighting device utilizing a number of light emitting diodes (LEDs) to produce the desired light. The LEDs are disposed between a heat sink and a translucent cover. Additional LEDs may be provided at other locations to enhance the light or to provide for other effects. These additional lights may be provided adjacent the primary LEDs or can be provided or grouped at one or both ends of such a solid rod. The LEDs may be in a series or parallel circuit array, as desired, or a combination thereof. A series circuit works well, as the reliability of such LED devices is such that it is unlikely that any will break down, which would result in loss of the entire series circuit. Moreover, a series circuit of LEDs allows the LEDs to act as a series of mutual voltage reduction devices for the other LEDs in the series circuit, thus reducing or eliminating some of or all of the additional electrical componentry which might otherwise be required.

As the LEDS have become more powerful over the years, and continue to gain more wattage, the need has become more critical to dissipate the heat generated by the LEDs. The present invention provides a heat sink along a top portion of the replacement light tube any connected to the LEDs to carry heat away from the LEDs to the outer periphery of the light tube

The light tube replacement device of the present invention which contains the LEDs, may be equipped with or cooperate with an adapter having fluorescent light receptacle attachment pins at each end thereof, in the manner of a conventional fluorescent tube. Unlike a standard fluorescent tube, it is not necessary for both sets of pins in each end to be electrically conductive; only a single pair of pins in one end of the device may need supply electrical power from the fixture to the LEDs and other electrical componentry, if so desired. Additional circuitry, e.g., a transformer, may be built into the translucent tube or installed at one end of the translucent rod, as desired or needed. Additionally, different connectors could be provide at one or both ends for use with a non-standard light fixture.

The replacement light tube preferably incorporates some form of reflective material in order to transmit the light laterally from one side of the rod or tube. The reflective material may be formed integrally with the translucent cover, an interior portion of the cover, the heat sink, or may be separated from each, for instance, sandwiched between the heat sink and the cover at the time of manufacture or assembly. A tinted translucent sleeve may be applied over the cover if so desired or may incorporated into the cover. Alternatively, the LEDs may be selected to emit a given color, in order to provide light output in a desired color range. The use of LEDs allows their intensity to be adjusted as desired by means of a conventional rheostat or similar control, unlike conventional fluorescent lights. The LEDs may also be controlled by a circuit to change colors, strobe or flash under certain conditions such as to alert personnel of fire or other hazards. See U.S. Pat. No. 7,249,865, which is incorporated herein by reference which shows the use of LEDs in a fluorescent light fixture to provide a warning system. In the present invention, the LEDs could be used to provide both the function of the standard fluorescent light tube and the function of the warning LEDs.

Accordingly, it is a principal object of the invention to provide a lighting device using the LED lighting principle for use as a direct replacement for a fluorescent tube in a conventional fluorescent lighting fixture, including any and all required electrical components to provide electrical compatibility and the required connector pins for physical compatibility with a conventional fluorescent light fixture, in for instance an adapter.

It is another object of the invention to provide such a replacement light unit which may utilize a replacement light tube containing a plurality of LEDs therein, or which may utilize a heat sink having a plurality of LEDs installed therealong and covered by a translucent cover, with optional LEDs grouped at one or both ends thereof.

It is yet another object of the invention to provide the components of the replacement light tube in a configuration which closely approximates the size and shape or external dimensions of a standard fluorescent light tube.

It is a further object of the invention to provide such a replacement light device which may incorporate the required electrical components for compatibility integrated within the device, or disposed externally to the device within the lighting fixture.

Still another object of the invention is to provide such a replacement lighting device which may include reflective means for distributing and diffusing the light output as desired, and/or tinting and/or LEDs which provide colored light output, for coloring the light output of the device as desired.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a light replacement tube according to one embodiment of the present invention.

FIG. 2 is a cross-sectional view of the light replacement tube along line 2-2 of FIG. 1.

FIG. 3 is a cross-sectional view along line 2-2 of FIG. 1 according to a second embodiment of the invention.

FIG. 4 is an exploded environmental perspective view showing the installation of an LED replacement light unit of the present invention in a conventional fluorescent light fixture.

view in section of a hollow translucent tubular embodiment of the present LED replacement light, showing its configuration and componentry.

FIG. 5 is a front plan view of the end caps according to an embodiment of the invention.

FIG. 6 is a front plan view of the end caps according to a further embodiment of the invention.

FIGS. 7A-7F are plan views of a replacement light tube constructed according to principals of the invention.

FIGS. 8A-8E are plan views of a further replacement light tube constructed according to principals of the invention.

Similar reference characters denote corresponding features consistently throughout the attached drawings.

### DETAILED DESCRIPTION OF THE PREFERRED EMBODIMENTS

The present invention comprises various embodiments of a lighting element adapted for installation in a conventional fluorescent lighting fixture. The lighting element may be referred to herein as a light tube replacement or replacement light tube (“light tube”) because it replaces a standard fluorescent tube and because of it may appear to be substantially cylindrical shape, but does not indicate the construction of the device as being hollow, solid or otherwise. Preferably, the light appears as the same size and shape as a fluorescent tube so that it is easily recognizable to a consumer and so that it fits within the same space in the fixture as a standard fluorescent tube. However, one skilled in the art would recognize that other shapes and sizes would may requirements of various lighting applications, would function in similar fashion and could be used in various applications.

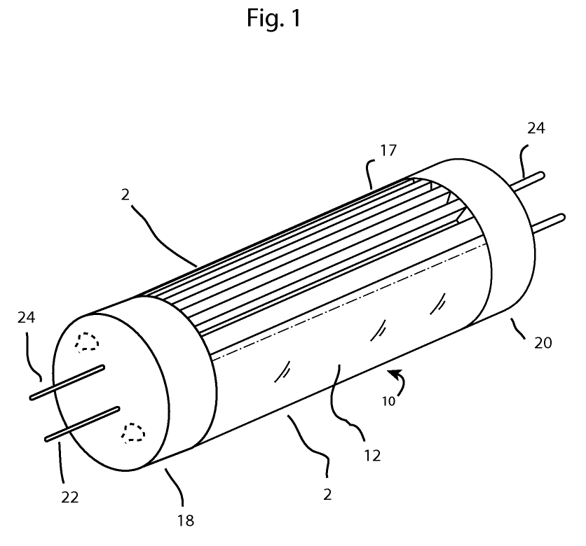

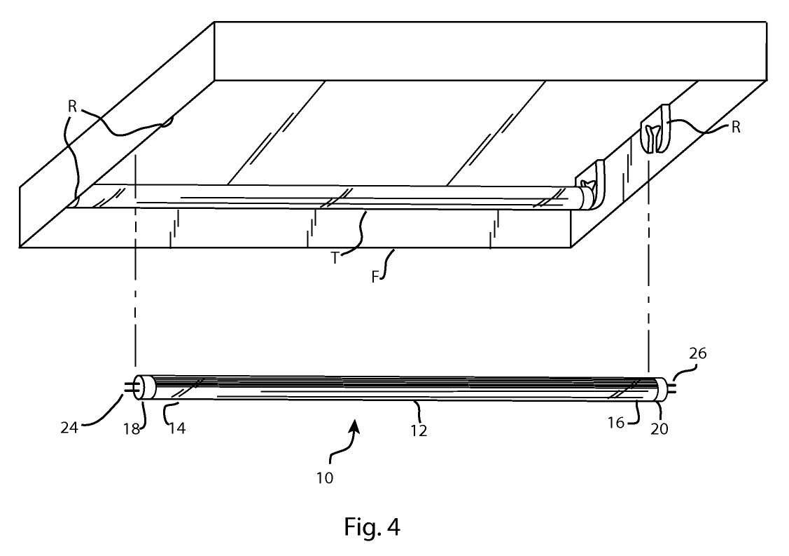

The replacement light tube contains one or more (preferably a plurality of) light emitting diodes (LEDs) therein, which provide the light emission from the device. As shown in FIGS. 1, 2 and 4, the installation of a first embodiment LED replacement lighting device 10, within an existing conventional fluorescent lighting fixture F. The fluorescent lighting fixture F (FIG. 4) is adapted to receive one or more elongate, fluorescent lighting tubes T therein, with the tubes T being secured between opposed electrical receptacles R. While the fluorescent fixture F illustrated in FIG. 4 comprises an overhead fixture containing two straight, elongate tubes or lighting elements, it will be seen that the present LED replacements for fluorescent lighting are adaptable to virtually any configuration of fluorescent lighting element, e.g., U-shaped, toroidal, etc.

FIG. 2 is a cross-sectional view of the light tube replacement device along line 2-2 of FIG. 1, which provides details of the construction of the LED replacement lighting element 10 shown generally in FIG. 1. The lighting element 10 comprises a solid translucent cover 12 having opposite first and second ends, respectively 14 and 16. The cover 12 may be formed of any optically transparent or clear material, or may be tinted as desired or may include a tinted sleeve (discussed further below) installed thereon. A relatively sturdy plastic such as acrylic is the preferred material, but other materials (glass, etc.) may be used to form the tube 12 as desired. As shown in FIG. 2, the acrylic may be made from one material or may be filled or coextruded with one or more secondary materials 15. In a preferred embodiment, colored acrylic is provided in a portion of the cover. This portion may be a white acrylic to reflect the light around the center to distribute and diffuse the light to provide a more uniform light across the light. The material 15 may also be selected to provide additional stiffness and/or to provide lower weight to the light or for other reasons and purposes, but is preferably acrylic. Additionally, instead of coloring the internal material 15, a reflective or diffusing layer can be provided between the layers or in place of the acrylic inner material to diffuse or deflect light around the central area. In a further embodiment, the inner area 15 may be a void within the acrylic, not filled with any material in order to save weight. A heat sink 17 is attached to an upper end of the cover 12. Preferably, the heat sink and the cover together have a generally cylindrical shape or fit within a cylindrical profile. The cover is generally formed as a hypothetical cylinder with a portion removed from an upper portion of the tube along a length of the tube. The heat sink generally conforms to the portion of the hypothetically cylindrical cover that has been removed. In this way, the combined portions form a substantially cylindrical lighting device approximating the shape of a standard fluorescent tube. A consumer may thereby recognize the replacement light tube and its intended function by its approximation of a standard fluorescent tube. Further, the replacement light will fit in the space vacated by a standard fluorescent tube when used to replace such tube, which may be important when access to the fixture is limited by a drop ceiling or the like. Additional components of the replacement light tube may be designed to fit between or around the heat sink and the cover, including but not limited to the end caps, LEDs and circuitry. Preferably all of the components taken together fit within the approximate shape and size of a standard fluorescent light tube. In some embodiments, however, electrical componentry, such as transformers or adapters, may be provided external to the lighting device.

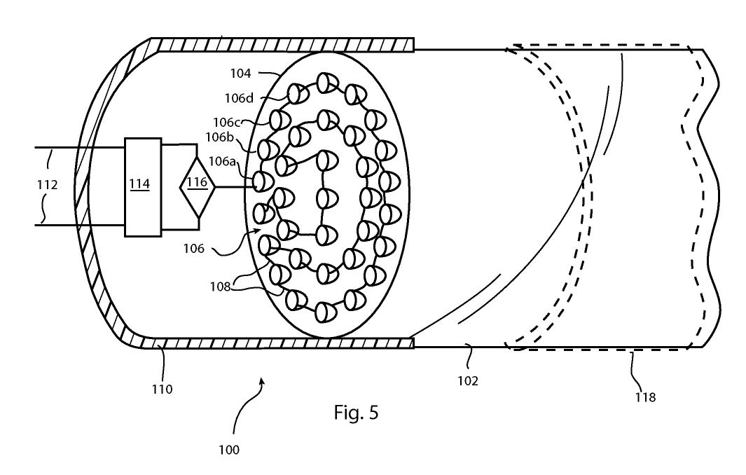

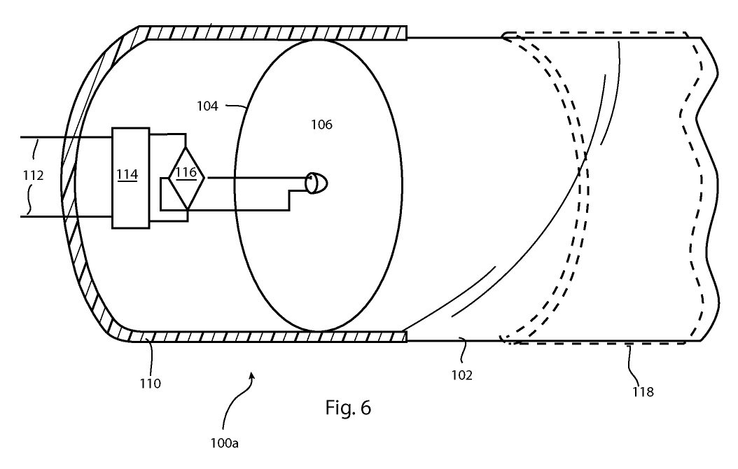

First and second end caps, respectively 18 and 20 (FIGS. 5 and 6), may be installed upon the respective first and second ends 14 and 16 of the cover 12. Each of the end caps 18 and 20 has a pair of parallel fluorescent light fixture receptacle connectors extending therefrom, with end cap 18 having connectors 22 and end cap 20 having connectors 24 extending therefrom. Each connector of each pair of connector pairs 22 and 24 is parallel to the other in its pair (and coaxial with the corresponding connector of the opposite connector pair), with the connectors 22 and 24 being configured for removably installing within the conventional opposed electrical receptacles R of a fluorescent lighting fixture F, as shown in FIG. 4. Again, other configurations of the present lighting device may be provided to conform to other fluorescent lighting installations.

Light emitting diodes (LEDs) are installed between the cover and the heat sink. Two exemplary LEDs 26, 26a are shown, but additional LEDs (not shown) are preferably located along the length of the heat sink. The LEDs 26 are electrically connected to one another by suitable means (e.g., wiring 28, elongate circuit board or flex circuit to which the LEDs are installed, etc.) and to an appropriate electrical power source. Preferably the LEDs are attached to a circuit board that is sandwiched between the heat sink and the cover with appropriate connections between the LEDs and the heat sink (e.g., by physical contact or by direct connection) to transfer heat away from the LEDs.

Preferably, the LEDs 26 are connected in series, as each LED acts as a voltage reducer for others in the circuit. This reduces the transformer differential which would otherwise be required to reduce the voltage for the LED array. The use of a series circuit which would terminate power to all of the LEDs in the event of a single LED failure, is not seen to be a problem. LEDs are sufficiently reliable that the loss of even a single LED in the circuit, is extremely unlikely.

LEDs conventionally require relatively low voltage, on the order of three volts per diode unit, even at their maximum light output. However, the typical fluorescent lighting fixture operates from a 115 volt wall outlet, and may have high voltage windings to produce enough potential to ionize the gases within the fluorescent tube. It will be seen that some form of step down transformer may be required with the present LED lighting device, unless a very large number of LED devices 26 is installed in series within the replacement light tube 12 or more powerful LEDs become commercially available. Preferably higher powered LEDs are used in such a number as to avoid the need for a transformer.

A bridge rectifier circuit may be installed within the light tube, an end cap or adjacent to the transformer. It will be seen that when using LEDs as the lighting principle for the present invention, that such a rectifier is not required. The LEDs themselves, being diode devices, automatically rectify any alternating current supply. However, a rectifier circuit may be provided with the present lighting device, if so desired.

The clear or translucent cover 12 of the lighting device 10 may be colored or tinted as desired to produce any given shade or over color of light as desired. Alternatively, or in addition to such tinting, at least some of the LEDs themselves may be selected to emit a specific color or wavelength of light, as desired. It is anticipated that most applications of the present invention would be best suited by the use of so-called “super bright” white LEDs, due to the broad range of color output across the spectrum and also due to their efficiency and relatively high light output. However, any type of LED desired may be used in the present lighting device.

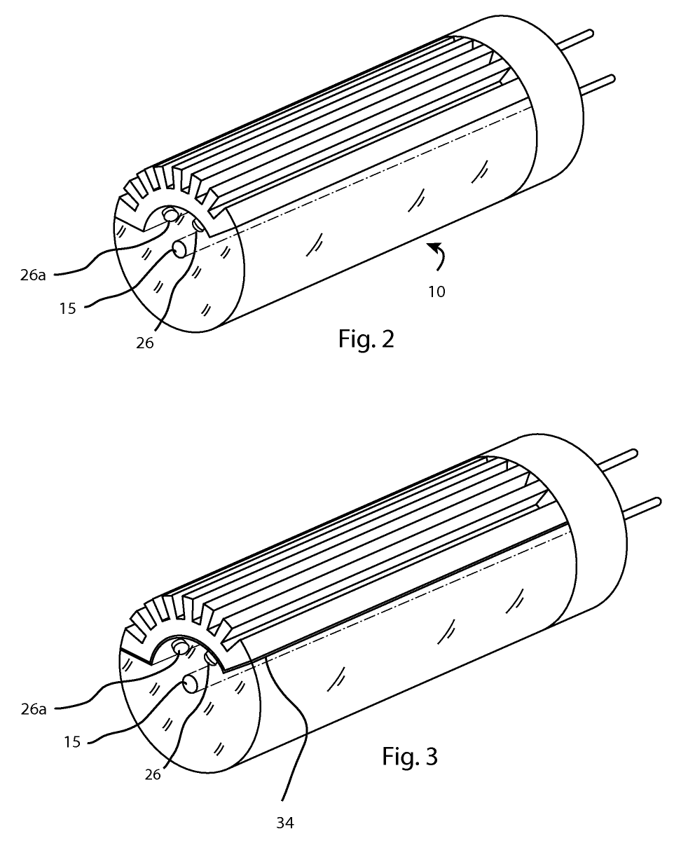

In order to provide further efficiency, some form of reflector disposed along the upper surface of the cover 12, is also desirable. The reflector may be in the form of a polished heat sink lower surface, however, preferably a reflective coating or material is provided at the upper surface of the cover. It should be noted that as shown in FIG. 3, the LEDs protrude below the surface of the heat sink or circuit board containing the LEDs. Portions of the acrylic may therefore be removed to provide for the placement of the LEDs while keeping the cover nearly flush with the heat sink (or circuit board, if provided). These removed sections preferably include a hemispherical portion to act as a lens to uniformly distribute the light while reflecting back as little light as possible, as will be explained further hereunder. Since the reflectors extend below the upper surface of the lens, a reflective coating or layer at the top of the acrylic will not interfere with the LEDs that protrude below this layer. By focusing the LEDs on the inner light diffuser 15, the light diffuser 15 along with the reflective coating 34 will distribute and diffuse the light along the entire translucent cover so that light will be uniformly delivered to the user. This prevents eye strain associated with irregular lighting patterns and generally enhances the effect of the light. Additionally imperfections or additives may be added to the cover to trap a number of photons within the tube to further provide the appearance of uniform lighting along the entire tube, that is to say, to give the light tube the appearance of a standard fluorescent light.

The reflector 34 may be a coating comprising a white, off-white, silver, or other color paint, tape, overlay, etc. disposed internally (FIG. 2A) or externally (FIG. 2B) about a portion of the circumference of the tube 12, as desired. This reflector 34 is preferably disposed about the upper portion of the cover 12 in an overhead lighting array, in order to reflect the light downwardly and outwardly from the fixture F as well as to hide a circuit board or wiring behind the LEDs. In other embodiments, such as that using a hollow cover, the reflector could instead be applied or attached directly to the circuit board or the heat sink or as needed for support in generally the same area relative to the LEDs.

The replacement light tube may have end caps similar to U.S. Pat. No. 6,860,628, shown here in FIGS. 5 and 6, with opposing ends and end caps (the first end 104 and end cap 110 are shown). The end cap 110 may contain the required electrical circuitry, i.e., transformer 114 and optional rectifier bridge 116, which receive their electrical energy from a pair of connector pins 112. An optional tinted or translucent sleeve 118 may be installed over the rod 102, as desired. However, the embodiment 100a of FIG. 5 differs from the embodiment 100 of FIG. 4, in that at least one LED 106 is installed at the end 104 of the rod 102 for the light device 100a of FIG. 5. Where “super bright” LEDs are used with relatively small and/or shorter light tubes, such a single LED installation may be sufficient, if an LED having sufficient light output is installed. It will also be seen that a single LED (or plural LEDs) may be installed at the opposite ends of the lighting device, if so desired.

Thus the present LED replacement lighting devices for fluorescent lighting systems, provide numerous advantages over conventional fluorescent lighting. The electrical power requirements for LED lighting are quite low in comparison to most other forms of lighting, thereby saving energy and increasing efficiency in comparison to other lighting forms. Moreover, the present system eliminates the need for relatively high step-up voltages, as it is not necessary to ionize gases within a standard tube, as is done in fluorescent lighting. This greatly reduces the potential hazard of such a system, as the voltage required is considerably lower than the conventional supply voltage (i.e., 110 to 115 volts) in most areas.

Another most important advantage of the present lighting system is that the potential danger of breakage of the relatively fragile, thin walled glass fluorescent tubes is eliminated, preventing escape of mercury or mercury vapor. A LED lighting device of the present invention having a plastic cover is far less prone to breakage than a conventional fluorescent glass tube. Even in the event that such an LED replacement light is cracked, it will still continue to function, as there is no containment of a gas under a relatively low pressure within the present lighting device. The use of a solid translucent or transparent cover, provides an even sturdier and stronger lighting device which greatly increases safety in hazardous environments (fuel vapors, explosives, etc.) for use in such areas as mines or other volatile area.

The present LED replacement lighting system provides further benefits in terms of emergency lighting, which cannot be easily achieved using fluorescent lighting. The provision of a relatively low voltage battery backup, enables the present system to function as an emergency lighting system. Fluorescent lighting systems are not practicable for such emergency lighting, due to their high voltage and alternating current requirements. Moreover, the present LED system enables one to provide lighting of virtually any color or hue desired, by means of different colored LEDs as desired. By connecting the light to a central control panel, the lights may change color, dim, flash or strobe, or some combination thereof to signal an emergency situation. Additionally, the lights may be dimmed to provide night lighting, especially for example in government facilities that require 24 hour lighting for security reasons. The lighting intensity is easily varied by means of a conventional rheostat or similar device, which light intensity variation is not possible with fluorescent systems. Alternatively, the lighting tube cover may be treated by mixing a light scattering polymer or other substance with the acrylic or other plastic, at the time of manufacture. The resulting translucent material serves to scatter and diffuse the light output from the LEDs, and may be tinted as desired. Thus, the present LED replacement lighting for fluorescent lighting systems will prove most valuable to the lighting industry.

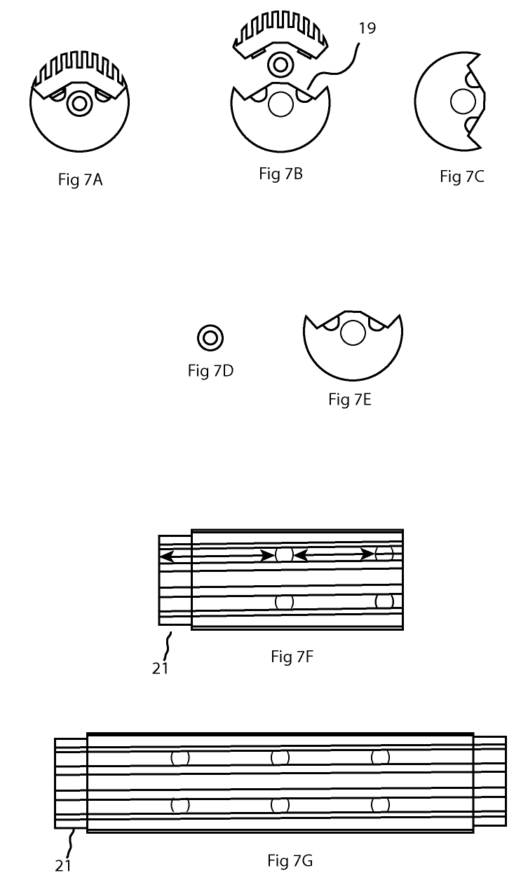

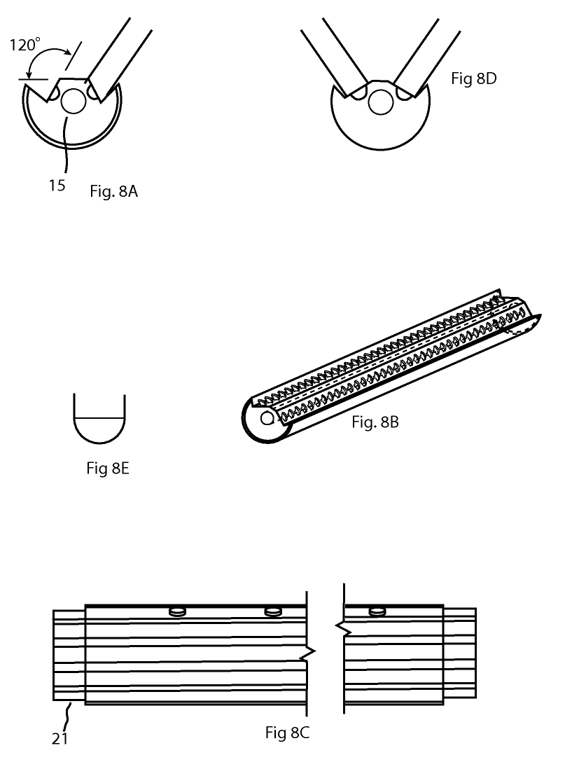

FIGS. 7A-G and 8A-D show further embodiments utilizing various principles of the invention. FIG. 7 shows side elevational views A, B and C showing a different fin design on the heat sink, wherein the fins are substantially vertical instead of radial. FIG. 7 also shows the voids 19 formed in the cover to receive the LEDs. The holes preferably terminate in a hemispherical shape to act as a lens to direct the light uniformly outward from the LEDs. The walls of the void 19 may be polished or otherwise treated to minimize any reflection of the light back on the LED while maximizing the amount of light transmitted into the cover. Preferably as shown in view E, there is an amount of space between the LED and the cover to allow for cooling of the LED and to minimize heating of the cover. Views F and G show an approximate one half inch 21 reduced neck on the cover and/or cover and heat sink to receive the end caps on the tube. Alternatively, the end caps can fit over the main diameter of the cover and heat sink. The heat sink may extend to the end of the cover or may terminate prior to the reduced neck portion. FIGS. 7A and 7B show placement of the LEDs to shine past the central reflector and into the cover, as opposed to the embodiment shown in FIG. 8A showing the placement of the LEDs arranged above the midline of the central reflector 15 and directly on the central reflector to reduce “spotlighting” caused by the LEDs and to provide substantially only indirect lighting out of the cover.

FIGS. 8A-8E show a further preferred embodiment utilizing aspects of the present invention. FIG. 8A shows LEDs aimed directly at central reflector 15. As shown in FIG. 8D, the central reflector may be ovoid (“egg shaped”), elliptical or a non-regular shape to better reflect light from the LEDs uniformly throughout the cover depending on the location of the LEDs, the shape of the cover and location of other lights throughout the cover. Preferably, the LEDs are spaced an equidistance A along the cover as shown in FIG. 8C. FIG. 8E shows a preferred shape of the void 19 in the cover to receive LEDs. One skilled in the art would recognize that the shape of the void could be altered as required by the shape of the LED or for other reasons. FIG. 8B shows a circuit board containing a number of LEDs mounted above the cover. Preferably 72 LEDs are distributed in two rows of 36 LEDs.

It is to be understood that the present invention is not limited to the embodiments described above, but encompasses any and all embodiments within the scope of the following claims, and the embodiments need not contain each and every feature or each and every object of the invention.

We claim:

1. A LED light for a replacing fluorescent light comprising a heat sink, a plurality of LED lights and a cover.
